(19) United States
(12) Patent Application Publication
(10) Pub. No.: US 2023/0115956 A1
(43) Pub. Date: Apr. 13, 2023

(54) Chlorine-Based Sodium Solid Electrolyte

(71) Applicant: THE REGENTS OF THE UNIVERSITY OF CALIFORNIA, Oakland, CA (US)

(72) Inventors: Ying Shirley MENG, La Jolla, CA (US); Erik WU, La Jolla, CA (US); Swastika BANERJEE, La Jolla, CA (US); Han Mei TANG, La Jolla, CA (US); Shyue Ping ONG, Palo Alto, CA (US); Abhik BANERJEE, La Jolla, CA (US)

(21) Appl. No.: 17/911,127

(22) PCT Filed: Mar. 12, 2021
(86) PCT No.: PCT/US2021/022197

§ 371 Date: Sep. 12, 2022

Related U.S. Application Data
(60) Provisional application No. 62/989,336, filed on Mar. 13, 2020.

(51) Int. Cl. H01M 10/0562; H01M 4/40; H01M 4/485; H01M 10/054

(52) U.S. Cl. CPC H01M 10/0562; H01M 4/40; H01M 4/485; H01M 10/054; H01M 2004/027; H01M 2300/008

(57) ABSTRACT

Sodium-based all solid-state batteries exhibit improved battery cycle life and stability with the use of a new chloride-based sodium solid electrolyte in which sodium diffusivity within the electrolyte is enhanced through substitution of atoms including one or more of Y with Zr, Ti, Hf, Ta, and Na with one or more of Ca and Sr.

### RELATED APPLICATIONS

This application claims the benefit of the priority of U.S. Provisional Application No. 62/989,336, filed Mar. 13, 2020, which is incorporated herein by reference in its entirety.

### FIELD OF THE INVENTION

The present invention relates to a sodium-ion conducting material that protects the high voltage oxide cathode/sulfide solid electrolyte interface in sodium all-solid-state batteries.

### BACKGROUND

Batteries for grid storage ideally employ low-cost materials and have long cycle life while also still having good energy density. While conventional liquid electrolytes have demonstrated good performance, they contain toxic and flammable materials. Such liquid electrolyte batteries, when used for grid storage applications, can run the risk of causing widespread damage from catastrophic fires. All solid-state batteries (ASSBs) have garnered increased attention in view of their superior characteristics relative to commercially-available liquid electrolyte batteries. In an ASSB, a non-flammable solid electrolyte is used instead of the liquid, making the battery inherently safer. A few of their advantages are the potential for increased energy density, the use of metallic anodes, and the improved safety of the non-flammable and non-corrosive solid-state electrolytes (SSEs). Solid-state electrolytes are also known to be more resistant to high temperatures, further mitigating safety concerns. For these reasons, research interest has continued to grow with regards to making better solid-state batteries.

Although there have been many advances in lithium-based solid-state batteries, their sodium counterparts have seen modest progress over the years. One of the main hurdles to commercialization of solid-state batteries has been the poor chemical and electrochemical stability between the solid-state electrolytes, which are typically sulfide-based, and sodium transition metal-based cathodes, usually oxide-based.

Sodium-based all-solid-state batteries have the potential to fill the growing demand for ASSBs. A typical rechargeable sodium ion secondary battery includes three main components: a positive oxide-based, transition metal-containing cathode, a negative metallic sodium anode, and a liquid electrolyte that can conduct sodium ions between these two electrodes. Incorporating sodium metal can be a challenge since it reacts with all the known electrolytes.

Much research has been focused on increasing the conductivity of SSEs themselves. The discovery and testing of various sulfide SSEs have proliferated due to the relative ease of processing and facile cell fabrication via cold-pressing. In sulfide-based sodium ASSBs, the sodium cations have more affinity with the oxide anions from the cathode compared with sulfide anions in the electrolyte based on the hard-soft acid base (HSAB) principle. Thus, transfer of sodium ions from sulfides to oxides will continually occur until equilibrium is reached. This degradation of the electrolyte will result in an interfacial layer that acts to suppress any ionic conduction across the interface.

In order to realize a practical ASSB, the chemical and electrochemical stability of the SSE against electrodes must be evaluated. Two major problems arise with sulfide solid electrolytes: first, sulfide SSEs are known to have a narrow electrochemical window. Exceeding this window, which occurs when a high voltage oxide cathode is used, leads to oxidative electrochemical decomposition of the solid electrolyte. Second, as described above, sulfide SSEs are intrinsically unstable against high voltage oxide cathodes, as the two battery components react at room temperature to form an ionically-and electronically-insulating layer. This layer, typically occurring at the cathode-electrolyte interphase (CEI), results in a low Coulombic efficiency (CE) during the first cycle and consequently a gradual increase in cell impedance. While protective cathode coatings have been used to improve the stability of the electrode-electrolyte interface, the chemical/electrochemical stability of the coating layer during prolonged cycling along with the electrochemical decomposition of sulfide SSEs during the first cycle still remain unavoidable challenges for sulfide SSEs when paired with a high voltage oxide cathode.

The motivation to search other chemical spaces comes from a recent report by X. Li, et al. (Energy Environ. Sci. 12, 2665-2671 (2019)) on new lithium-conducting SSEs, namely the halide-based Li₃YCl₆ (LYC) and Li₃YBr₆ (LYB). The room temperature Li⁺ conductivity of these compounds is 0.5 mS/cm and 0.7 mS/cm, respectively, making them suitable as solid-state electrolytes in ASSBs. In this report, LYC or LYB was used as the electrolyte in a solid-state cell composed of a Li-In alloy anode and a LiCoO₂ (LCO) cathode; notably, no protective coating was used on LCO, yet a first cycle Coulombic efficiency of ~94% was achieved with good capacity retention over 100 cycles. This stable cycling indicates that these halide-based SSEs have a much wider electrochemical window than sulfides, further evidenced by the lack of a protective coating.

The sodium analogues of lithium-conducting SSEs have also been explored, as sodium is a more abundant material generally and often behaves similarly to lithium in electrochemical materials. Sodium, having the second-lowest electrochemical potential versus SHE (-2.70 V to Lithium’s -3.07 V), is commonly touted as a potential cost-effective option for batteries, especially those for large-scale grid storage applications, where operating cost is more strongly emphasized than energy density. See, e.g., Y. Wang, et al., Nano Mater. Sci. 1, 91-100 (2019). As such, the development of new sodium electrolytes, which involves an understanding of their operating mechanisms and compatibility with common sodium battery electrodes, remains of significant interest.

Atomic substitution of chloride-based sodium solid electrolytes has not previously been reported. Their lithium counterparts, which have been reported in literature, do not need such atomic substitution as their conductivity is high enough for use in batteries. Chloride-based sodium-ion (Na⁺) conductors, previously reported to have much wider electrochemical stability windows than their sulfide counterparts, are ripe for exploration and incorporation into sodium all-solid-state batteries.

Notwithstanding the aforementioned advancements, the need remains for materials to address the multitude of obstacles to the commercialization of efficient ASSBs. The present invention is directed to such a need.

### SUMMARY

In one aspect of the invention, a novel chlorine-based material is provided that can conduct sodium ions as well as having higher intrinsic chemical and electrochemical stability with high voltage cathodes, preventing unwanted reactions between the solid-state electrolyte and cathode, leading to the ability for more stable battery cycling.

A novel class of materials — chloride-based sodium-ion (Na⁺) conductors— is useful in a cathode composite in ASSBs that contain an oxide cathode in order to prevent decomposition of the sulfide electrolyte and unwanted interfacial chemical reactions that ultimately lead to degradation of solid-state battery performance. In one embodiment, the new class of Na⁺ conductors is based on the halide parent compound Na₃YCl₆, which, for brevity, will be referred to herein as “NYC”.

Na₃₋ₓY₁₋ₓZrₓCl₆ (with 0 < x < 1, herein referred to as “NYZC”) compounds were synthesized and their electrochemical performance evaluated. Given the wider electrochemical window of NYZC (upwards of 3.8 V) and superior chemical stability when in contact with oxide cathodes, the material could be incorporated into a sodium ASSB containing oxide cathode NaCrO₂, notably without the use of any protective coatings on the cathode side. Such an ASSB can last several hundreds of cycles even at C/2, making it one of the best performing all solid-state Na-ion batteries reported to date.

Through the use of computational methods and ab initio molecular dynamics (AIMD) simulations, it was found that aliovalent substitution, namely substitution by Zr⁴⁺, Hf⁴⁺, or Ti⁴⁺ for Y³⁺, and by Ca²⁺ or Sr²⁺ for Na⁺, drastically improved the sodium diffusion properties of the material no matter the dopant element. Since it was found to be energetically favorable to substitute Zr⁴⁺ for Y³⁺ in the crystal, this substitution was experimentally demonstrated and tested. Substitution of Zr⁴⁺ for Y³⁺ leads to the chemical formula Na₃₋ₓY₁₋ₓZrₓCl₆ (NYZC), with 0 < x < 1. The electrochemical properties of a series of Na₃₋ₓY₁₋ₓZrₓCl₆ compounds, such as their reaction energy with electrodes, electrochemical window, and electrochemical performance, were computationally and experimentally evaluated. After the incorporation of NYZC in a model sodium ASSB (containing Na-Sn 2:1 alloy as the anode, Na₃PS₄ as the electrolyte, and NaCrO₂ as the cathode), the first cycle Coulombic efficiency (CE) drastically increased from ~72% to ~95% and the ASSB displayed relatively stable electrochemical performance over hundreds of cycles without drastic capacity fade.

The novel materials described herein allow the fabrication of stable high voltage sodium all solid-state batteries for potential use in grid-scale energy storage applications. Batteries for grid storage ideally employ low-cost materials and have long cycle life while also still having good energy density. Sodium-based all-solid-state batteries have the potential to fill this need in order to enable commercialization of such batteries.

In one aspect of the invention, a composition for sodium-based all-solid-state batteries includes a halide compound comprising a chloride-based sodium solid electrolyte, wherein sodium diffusivity within the halide compound is enhanced through substitution of one or more of Zr, Ti, Hf, Ta, Ca, Sr, Mg, and Fe. In some embodiments, the electrolyte is based on a parent compound Na₃YCl₆. The electrolyte may be an engineered framework with Na-deficiency compared to the parent Na₃YCl₆. In some embodiments, the electrolyte is Na₃₋ₓY₁₋ₓZrₓCl₆ where 0 < x < 1, and further may be Na_{2.25}Y_{0.25}Zr_{0.75}Cl₆.

In another aspect of the invention, a sodium-based all-solid-state battery includes a sodium-based solid electrolyte, and a composite cathode including an oxide cathode and a chloride-based sodium solid electrolyte, wherein sodium diffusivity within the electrolyte is enhanced through substitution with one or more of Zr, Ti, Hf, Ta, Ca, Sr, Mg, and Fe. In some embodiments, the sodium-based solid electrolyte may be a sulfide and may be Na₃PS₄ and the oxide cathode is a transition metal oxide, NaCrO₂. The battery may further include an anode comprising NaₓSn, NaₓSb, or NaₓSb_{y}Sn_{1-y} alloys. In some embodiments, the sodium-based solid electrolyte in the battery is stable with the alloy anodes. The battery may have a capacity retention of greater than 80% after more than 200 cycles, preferably 80% after more than 500 cycles, and more preferably, more than 89% after 1000 cycles.

In still another aspect, a sodium-based all-solid-state battery having a sodium-based solid-state electrolyte and an oxide cathode is characterized in that one or more metallic elements M selected from Ca, Sr, Ti, Zr, Hf, Ta, Ca, Sr, Mg, and Fe are substituted into pristine Na₃YCl₆ at Na or Y sites to define a buffer layer between the sodium-based solid electrolyte and the cathode. In some embodiments, the sodium-based solid electrolyte may be a sulfide and may be Na₃PS₄ and the oxide cathode is a transition metal oxide, NaCrO₂. The battery may further include an anode comprising NaₓSn, NaₓSb, or NaₓSb_{y}Sn₁_{-y} alloys. In some embodiments, the sodium-based solid electrolyte in the battery is stable with the alloy anodes. The buffer layer may be an engineered framework with Na-deficiency compared to the parent Na₃YCl₆ and in some embodiments is Na₃₋ₓY₁₋ₓZrₓCl₆, where 0 < x < 1, or is Na_{2.25}Y_{0.25}Zr_{0.75}Cl₆. The battery may have a capacity retention of greater than 80% after more than 200 cycles , preferably 80% after more than 500 cycles, and more preferably, more than 89% after 1000 cycles.

In yet other aspect, a composition comprises a sodium-ion conducting material configured for use as an interface between a high voltage oxide cathode and a sodium-based solid electrolyte in a sodium all-solid-state battery, wherein the material is based on a parent compound Na₃YCl₆. In some embodiments, the parent compound is substituted with one or more of Zr, Ti, Hf, Ta, Ca, Sr, Mg, and Fe. In other embodiments, the material is Na₃₋ₓY₁₋ₓZrₓCl₆, where 0 < x < 1, or Na_{2.25}Y_{0.25}Zr_{0.75}Cl₆. In some embodiments, the sodium-based solid electrolyte may be a sulfide and may be Na₃PS₄ and the oxide cathode may be a transition metal oxide, NaCrO₂.

### BRIEF DESCRIPTION OF THE DRAWINGS

FIG. 1 shows Rietveld refinement of the capillary X-ray diffraction (XRD) data pattern of the as-synthesized Na₃YCl₆ (“NYC”).

FIG. 2 is a Nyquist plot for Na₃YCl₆ (NYC) measured at room temperature, showing a sodium ion conductivity of 9.5 × 10⁻⁸ S/cm at room temperature. The inset shows the equivalent circuit used to fit the spectra.

FIG. 3 is a table comparing properties or Na₃YBr₆ (NYB), NYC, and Na_{2.5}Y_{0.5}Zr_{0.5}Cl₆.

FIGS. 4A-4B show phase stability and MSD, respectively, of the quaternary compounds if NYC undergoes aliovalent substitution in the Na—Y—M—Cl (M = Ca, Sr, Ti, Zr, Hf, Ta) phase-space; FIG. 4C is an AIMD simulation derived MSD for Na-ion at 800 K for the nominal compositions of substituted NYC compared with pristine NYC. In every case, aliovalent substitution drastically increased the Na-ion diffusivity.

FIGS. 5A-5D show the effect of Zr dopants on properties of Na₃YCl₆, where FIG. 5A illustrates the crystal structure of Na₃YCl₆; FIG. 5B plots stability of Na₃₋ₓY₁₋ ₓZrₓCl₆ after incorporating Zr⁴⁺ into Na₃YCl₆. FIG. 5C is a graph of the electrochemical stability window of Na₃₋ₓY₁₋ₓZrₓCl₆ (0 ≤x ≤1), with the window of Na₃PS₄ (NPS) as a reference; and FIG. 5D is an Arrhenius plot for Na₃₋ₓY₁₋ₓZrₓCl₆ from simulations.

FIGS. 6A-6D are plots of the probability density (isosurface value = 5 × 10⁻⁴) of Na+ in Na₃YCl₆ (FIG. 6A); Na⁺ in Na_{2.25}Y_{0.25}Z_{0.75}Cl₆ (FIG. 6B); Cl⁻ in Na₃YCl₆ (FIG. 6C) and Cl⁻ in Na_{2.25}Y_{0.25}Z_{0.75}Cl₆ (FIG. 6D) over 100 ps of AIMD simulations at 600 K ; FIG. 5E plots the Na⁺ diffusivity at 800 K (D_{800K}, in cm²/s) for varying Zr content in Na₃₋ₓY₁₋ₓZrₓCl₆.

FIG. 7A provides the XRD patterns for Na₃₋ₓY₁₋ₓZrₓCl₆ compositions obtained in x = 0.125 increments; FIG. 7B is a graph of the room temperature Na ionic conductivity as a function of Zr percentage, respectively; and FIG. 7C is the Arrhenius plot of the sample with the highest Na ionic conductivity, Na_{2.25}Y_{0.25}Zr_{0.75}Cl₆.

FIGS. 8A-8H are XPS plots of the Na 1s, Y 3d, Cl 2p, and Zr 3d binding energy regions for (8A-8D) NYC and (8E-8H) NYZC0.5, respectively.

FIGS. 9A and 9B are Nyquist plots for Na₃₋ₓY₁₋ₓZrₓCl₆, 0.25<×<0.75 (shown for scale) and the room temperature Na ionic conductivity for Na_{2.25}Y_{0.25}Zr_{0.75}Cl₆, respectively. The inset of FIG. 9B is an SEM image that shows the morphology of the Na_{2.25}Y_{0.25}Zr_{0.75}Cl₆ pellet.

FIG. 10 is the Rietveld refinement result of as-synthesized Na₂ZrCl₆. Cell parameters and fitting parameters are shown in the inset.

FIG. 11 shows XRD patterns used for determination of the structure of Na₂ZrCl₆.

FIG. 12A is a grand potential diagram of Na_{2.25}Y_{0.25}Zr_{0.75}Cl₆; FIGS. 12B and 12C respectively show the reduction and oxidation voltage profiles of the Na-Sn 2:1|NPS|Na_{2.25}Y_{0.25}Zr_{0.75}Cl₆: carbon composite ASSB.

FIG. 13A shows the cell schematic of the NPS-only cell; FIGS. 13B and 13C show the voltage profile and capacity as a function of cycle number, respectively, at 20° C. and at a rate of C/10; FIGS. 13D-13E show the voltage profile and capacity as a function of cycle number, respectively, at 40° C. and at a rate of C/10.

FIG. 14A shows the cell schematic of the cell with Na_{2.25}Y_{0.25}Zr_{0.75}Cl₆ in the composite cathode; FIGS. 14B-14I show the voltage profile and capacity as a function of cycle number, respectively, at 20° C. and at a rate of C/10 (FIGS. 14B-14C), at 20° C. and a rate of C/2 (FIGS. 14D-14E), at 40° C. and a rate of C/2 (FIGS. 14F-14G), and 40° C. and a rate of 1C (FIGS. 14H-14I).

FIGS. 15A-15H a plots of Zr 3d and Y 3d binding energies, respectively, for (FIGS. 15A-15B) Pristine Na_{2.25}Y_{0.25}Zr_{0.75}Cl₆; FIGS. 15C-15D, room temperature cycled NaCrO₂: Na_{2.25}Y_{0.25}Zr_{0.75}Cl₆:VGCF composite cathode, FIGS. 15E-15F, 40° C. cycled NaCrO₂: Na_{2.25}Y_{0.25}Zr_{0.75}Cl₆:VGCF composite cathode, and FIGS. 15G-15H, 40° C. cycled NaCrO₂: Na_{2.25}Y_{0.25}Zr_{0.75}Cl₆:VGCF composite cathode at a rate of C/2.

### DETAILED DESCRIPTION OF EMBODIMENTS OF THE INVENTION

The inventive material starts with the Na₃YCl₆ parent compound. 4+ ions are preferentially found to take the place of yttrium, so that, upon elemental substitution, the empirical formula becomes Na₃₋ₓY₁₋ₓAₓCl₆, where A═Hf, Zr, Ti and 0<x<1. In addition, 2+ ions can take the place of the sodium atom, meaning the formula will become Na₃₋₂ₓBₓYCl₆, where B═ Ca, Sr. Sodium vacancies are created in both cases to balance the charge.

Experimental synthesis of the parent Na₃YCl₆ (“NYC”) compound was carried out by mixing NaCl and YCl₃ in stoichiometric amounts in a mortar and pestle. After ball milling for 2 hours at 500 rpm, the material was flame sealed in a quartz tube and heated at 500° C. for 24 hours. Afterwards, the material was ball milled again for 4 hours at 400 rpm to get the final powder. Characterization of the material was carried out via X-ray diffraction in a sealed boron-rich capillary tube. To incorporate zirconium, a third salt, ZrCl₄, was introduced before the mixing and heating process. The compositions of Na₃₋ₓY₁₋ₓZrₓCl₆, made at every x=0.125 increment, were carried out using the appropriate ratio of NaCl to YCl₃ to ZrCl₄. For all samples, XRD was performed and the conductivity was measured in the same way, by pressing a pellet in a 10 mm-diameter PEEK mold using titanium plungers. Further details of the synthesis, fabrication and testing procedures are provided below.

Methods: All density functional theory (DFT) calculations were performed using the Vienna Ab initio Simulation Package (VASP) package (University of Vienna) within the projector augmented wave (PAW) method. The Perdew-Burke-Emzerhof generalized-gradient approximation (GGA) was used to model the exchange-correlation for all chemistries. A plane-wave cut-off 520 eV was used for all cases to keep consistent with Pymatgen package settings. All input file generation and analysis of results were performed using Pymatgen and pymatgen-diffusion packages as are known in the art.

Generation of the set of structures and geometry analysis: The Materials Project (MP) open source library and the Inorganic Crystal Structure Database (ICSD) (FIZ Karlsruhe) are the source of crystallographic data in the computation. Additional precomputed crystalline data, such as the space group, the band gap, the energy above hull (Eₕᵤₗₗ) and the decomposition products, were also extracted from MP database using the Materials Project API.

The structures of Na₃YCl₆ and Na₃YBr₆ were extracted from MP database, which are indexed as mp-31362 (ICSD#59886) and mp-29080 (ICSD#82355), respectively. Aliovalent-doping or substitution of selected metallic elements M (M = Ca, Sr, Ti, Zr, Hf, Ta) into pristine Na₃YCl₆ at Na or Y sites were performed to identify the promising optimization strategies.

Identifying a new compound from experimental XRD data alone can be challenging. In this study, Na₂ZrCl₆, having a distinct crystal structure, was investigated in order to determine the structure. Three groups of theoretical structures were generated: (a) substituted Zr at Y sites using the 3 pristine Na₃YCl₆ structures (mp-675104, mp-31362 & mp-1111487); (b) substituted all structures in MP database matching the formula of A₂MX₆ to Na₂ZrCl₆; (c) utilized the compound prediction tool in Pymatgen package to generate all possible compounds in Na—Zr—Cl chemical space. All candidate structures were fully relaxed, and the experimental structure was successfully obtained from the pool.

Topological analysis of the framework chemistries was performed using Zeo++, an open-source topological analysis package. The quantity of interest is the largest included sphere radius along the free sphere path R_{inc}. This gives an estimate of the diffusion channel size which is associated with the ionic conductivity of the material.

To determine the reaction energy between two components, the phase diagram between the two reactants was constructed. The energy of the energetically most favored reaction is used to represent the reaction energy between the contacting interface (e.g., the selected electrolyte/cathode interface).

Kinetic simulations to study the diffusion properties of candidates: The diffusivity and conductivity of the selected compounds including NYC and NYC-derivatives were calculated using non-spin polarized Ab-initio Molecular Dynamics (AIMD) in NVT ensemble. A smaller plane-wave energy cutoff was selected as 280 eV. Supercells with the minimum dimension larger than 10 Å and a minimal Γ-centered 1×1×1 k-mesh are used. The time step was set to 2 fs. All AIMD calculations were performed using automated in-house AIMD workflow program. Diffusivities were obtained at the range of temperature between 400 K and 1200 K depending on the melting point of the material. Activation energy is obtained by plotting a converged Arrhenius plot at selected temperatures using the Nernst-Einstein relation. Selective dynamic scheme was also applied to Zr doped/substituted-NYC compositions to understand the effect of Cl motion on the Na diffusion mechanism. Climbing image nudged elastic band calculations (CI-NEB) calculations are applied to get the activation energy of a Na-ion migration path²⁹ for NYC and NYC substituted by Zr at Y site.

Machine learning interatomic potential and molecular dynamic simulations: The moment tensor potential (MTP) for NYZC0.75 was developed using the open-source Materials Machine Learning (maml) Python package. The training data comprises 800 snapshots extracted at 400 fs intervals from AIMD NVT simulations at 600 K, 800 K, 1000 K, and 1200 K. Static DFT calculations were then performed to obtain accurate energies and forces. A training:test split of 90:10 was used to train the machine learning model. The MTP cutoff radius and the maximum level of basis functions, levₘₐₓ were chosen to be 5.0 Å and 14, respectively. The mean absolute error (MAE) on the energies and forces were 1 meV atom⁻¹ and 63.5 meV Å⁻¹, respectively. NPT MD simulations using the MTP were carried out using LAMMPS.⁴ The simulation time was at a least amount of 10 ns with a 2 fs time step. A 4 × 4 × 4 supercell of the NYC0.75 with 592 atoms was used.

### Experimental Synthesis and Characterization

Electrolyte Synthesis: All fabrication processes were conducted in an Ar-filled glovebox (mBraun 200B, H₂O ppm <0.5, O₂ ppm < 1), unless otherwise noted. Stoichiometric amounts of the precursors NaCl (>99%, Sigma Aldrich), YCl₃, (99.9%, Sigma Aldrich) were hand-mixed in a mortar and pestle for 10 minutes and the powder mixture was placed in a 50 mL ZrO₂ ball mill jar (Retsch Emax) with eleven 10 mm-diameter Y—ZrO₂ milling balls. The mixture was milled for 2 hours at 500 rpm. The material was extracted from the jars in the glovebox, pelletized at a pressure of 370 MPa with a 13 mm pellet die (Carver), loaded into a quartz tube, flame sealed, and heated in a box furnace (Lindberg Blue M) at 500° C. for 24 hours. For uniformity, the material was ball milled again after heat treatment using 88 5 mm diameter Y-ZrO₂ milling balls for a duration of 4 hours. The material was extracted and stored in the glovebox for further testing.

For the Zr substitutions, the aforementioned procedure was conducted, except with the introduction of ZrCl₄ (99.99%, Sigma Aldrich) as a third precursor and the reagent ratios adjusted accordingly.

Characterization - XRD: Powder samples were loaded into 0.5 mm-diameter boron-rich capillary tubes (Charles Supper). The tube opening was capped with clay and wrapped in paraffin film before it was brought outside of the glovebox to be flame-sealed with a butane torch. The samples were measured on a Bruker Kappa goniometer equipped with a Bruker Vantec 500 detector. The sample was placed in the Bragg-Brentano θ-θ configuration and the Debye-Scherrer method was used for measurements. XRD data was collected using Cu Kα radiation at 45 kV and 50 mA, over a 2θ range of 5-90° with a step size of 0.01°.

For Synchrotron XRD, the samples were prepared by loading the powders into polyimide tubes in the glovebox and were subsequently sealed with epoxy.

Electrochemical Characterization: The powder was pressed at 370 MPa into a 10 mm polyether ether ketone (PEEK die) using two titanium plungers. On both sides of the pellet, acetylene black (AB) was added for better contact with the current collectors; once added, the AB was pressed at 370 MPa using the titanium plungers. The cell configuration was secured into a cell holder and connected to a Solartron 1260 impedance analyzer. Impedance measurements were taken with an applied AC potential of 30 mV over a frequency range of 1 MHz to 1 Hz. Temperature-dependent EIS measurements were also conducted within the glovebox; the sample was heated from 20° C. to 100° C. and EIS measurements were recorded at every 20° C. increment. Measurements were taken only after the sample was held at the target temperature for over an hour to allow for equilibration. The heating rate was 2° C./min. The activation energy (Eₐ) was calculated from the slope of the resulting Arrhenius plot.

The model all solid-state battery contains the NaCrO₂ positive electrode, a Na-Sn (2:1) negative electrode, and Na₃PS₄. The positive electrode is then mixed into a composite with a weight ratio of 11:16:1 of NaCrO₂:solid electrolyte:vapor-grown carbon fibers (VGCF, Sigma Aldrich) The all solid-state battery is manufactured through mechanical pressing; 75 mg of Na₃PS₄ powder is pressed first at 370 MPa, then about 12 mg of the composite NaCrO₂ powder is placed on one side of the Na₃PS₄ pellet and pressed at the same pressure, and then on the opposite side of the Na₃PS₄, an excess of Na—Sn 2:1 alloy (35 mg) is pressed at the same pressure. After securing the cell in a cell holder, the electrical leads were connected to the electrochemical cycler (Landhe). The current used was 50 µA which corresponded to a rate of C/10.

To incorporate the NYZC material into the model ASSB, the NYZC would take the place of Na₃PS₄ in the composite cathode (still hand-mixed with the same 11:16:1 ratio). 15 mg of NYZC would either be pressed on top of Na₃PS₄ before pressing the composite cathode to make a “bilayer cell”, or simply the NYZC-containing composite cathode would be pressed onto Na₃PS₄ to make the “monolayer” cell. For cells cycled at 40° C., the cell assemblies were placed into a compact muffle furnace (MTI KSI-1100X) within the Ar-filled glovebox. After cycling, the cell was disassembled to characterize any material changes.

X-ray Photoelectron Spectroscopy (XPS): The powders were adhered onto a small metallic sample stub (Shimadzu Corporation, Kyoto, Japan) with carbon tape. The stub was placed into a custom 3-D printed holder inside a 30 mL LDPE bottle and the lid secured with paraffin film. The bottle was placed into a metallic tube and sealed inside the glovebox with clamps.

The metallic canister was placed into a N₂ glovebox that is attached to the XPS tool (Kratos Axis Supra from Kratos Analytical Ltd., Manchester, UK), where the sample can be transferred into the analysis chamber without any exposure to ambient air. All measurements were taken using 15 kV Al Kα radiation at a chamber pressure less than 5 × 10⁻⁸ torr. For the wide survey scans, a pass energy of 160 eV and a dwell time of 100 ms was used, but for specific element regions, a pass energy of 20 eV, a dwell time of 300 ms, and a step size of 0.05 eV was used. The charge neutralizer was enabled during all the measurements. Data calibration and analysis were conducted by the CasaXPS software (Casa Software Ltd.), and all region spectra were calibrated using the C 1s peak.

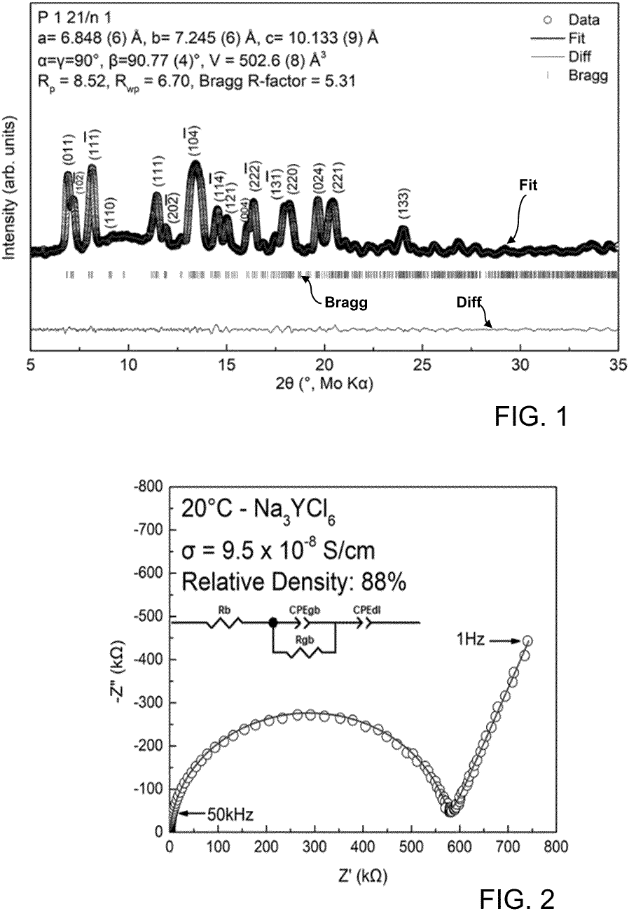

Results and Discussion: Na₃YCl₆ was first synthesized using a combination of NaCl and YCl₃ precursors. To verify its synthesis, air-sensitive capillary X-ray diffraction (XRD) was conducted on NYC. Rietveld Refinement was conducted using the FullProf software suite; the crystal structure of this compound was found to be monoclinic, with space group P21/n. The XRD pattern is shown in FIG. 1. Rietveld refinement results showing the atomic position, Bᵢₛₒ, and occupancy values for Na₃YCl₆. are provided in Table 1.

TABLE 1

| Atom | × | y | z | Bᵢₛₒ | SOF |
|---|---|---|---|---|---|
| Y | 0 | 0.5 | 0 | 3.1 (5) | 1 |
| C11 | 0.132 (3) | 0.567 (3) | 0.245 (4) | 3.5 (4) | 1 |
| C12 | 0.168 (4) | 0.801 (3) | 0.929 (3) | 3.5 (4) | 1 |
| C13 | 0.321 (4) | 0.325 (4) | 0.928 (3) | 3.5 (4) | 1 |
| Na0 | 0.519 (5) | 0.423 (3) | 0.245 (4) | 1.8 (7) | 1 |
| Na1 | 0.5 | 0 | 0 | 1.8 (7) | 1 |

FIG. 2 is the Nyquist plot for Na₃YCl₆ measured at room temperature, showing a sodium ion conductivity of 9.5 × 10⁻⁸ S/cm at room temperature. The inset shows the equivalent circuit used to fit the spectra.

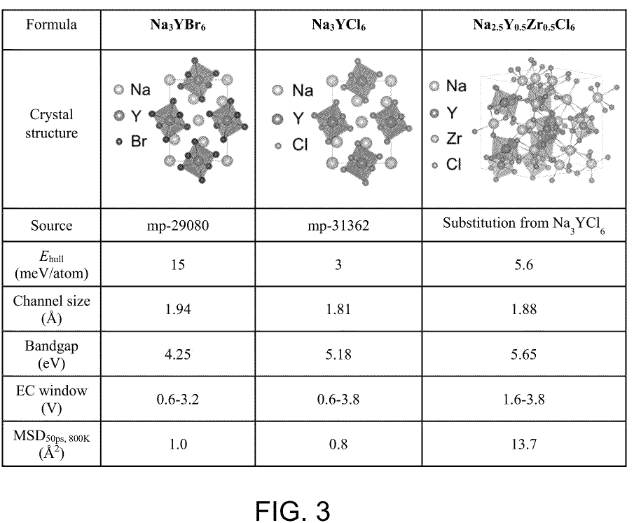

To computationally evaluate the Na⁺ diffusion properties of these compounds, the Na mean-squared displacement (MSD) was obtained through AIMD simulations for all NYC compounds (and for isostructural bromine, Na₃YBr₆). The results are provided in FIG. 3 in which the crystal structure, thermodynamic stability (Eₕᵤₗₗ), Na⁺ diffusion channel size, electronic band gap, and electrochemical stability window (EC window) are tabulated. The mean squared displacement of Na⁺ for a 50 ps time scale at 800 K (MSD_{50ps,} _{800K}) is negligible for Na₃YCl₆ (NYC) and Na₃YBr₆ (NYB), implying that NYC and NYB exhibit little to no Na⁺ diffusivity.

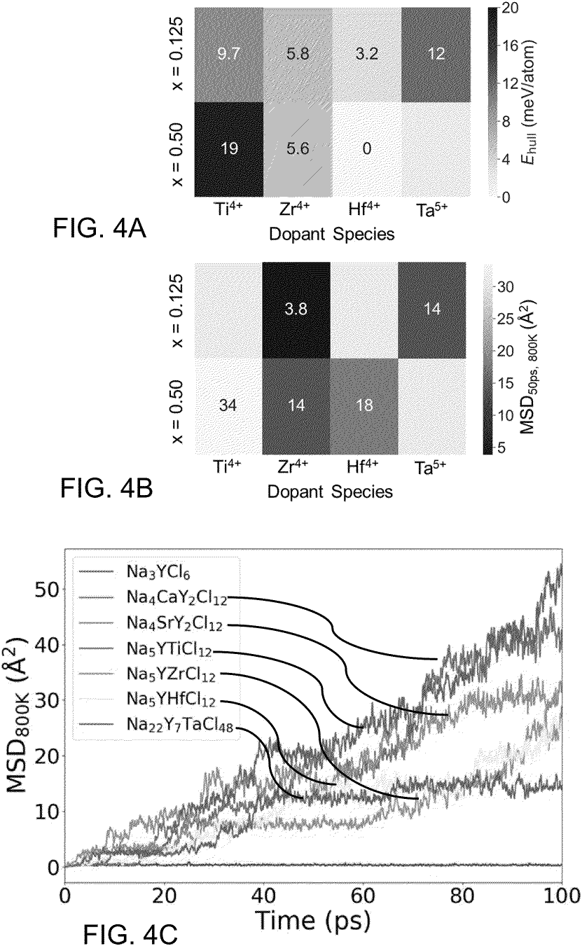

To modify such a compound in order to increase its ionic conductivity, aliovalent doping is a promising avenue. Starting from a defect-free crystal where all sites are occupied and there are no channels for ions to migrate, aliovalent doping introduces interstitials or vacancies in the SSE structure which can enhance Li⁺ or Na⁺ diffusion. To explore this, elements that can substitute into NYC were identified by computational methods. FIGS. 4A and 4B compare phase stability of quaternary compounds if NYC undergoes aliovalent substitution in the Na—Y—M—Cl (M = Ca, Sr, Ti, Zr, Hf, Ta) phase-space. FIG. 4A provides a summary of the computational results, namely the energy penalty incurred upon substituting various elements into the Na or Y sites of the NYC framework. FIG. 4B shows mean squared displacement of Na⁺ for a 50 ps time scale at 800 K (MSD_{50ps,800K}) of Na_{3-z-3)x}Y₁₋ₓM^{z+}ₓCl₆ (M^{z+} = Zr⁴⁺, Ta⁵⁺, x = 0.125; M^{z+} = Ti⁴⁺, Zr⁴⁺, Hf⁴⁺, x = 0.50). Light gray regions indicate either an unstable compound (due to significant Na⁺ loss for Ta⁵⁺ at x = 0.50) or in the case of MSD screening, preferentially conducted for the higher dopant concentrations for Ti⁴⁺ and Hf⁴⁺ (stable at x = 0.50).

FIG. 4C provides the results of AIMD simulation derived MSD for Na-ion at 800 K for the nominal compositions of substituted NYC compared with pristine NYC. In every case, aliovalent substitution drastically increased the Na-ion diffusivity. The Na-MSD was computed on the nominal or most stable compositions of aliovalently doped-NYC. Every substitution resulted in a drastic increase in the Na MSD. After 80-100 ps, little to no Na diffusivity was observed in the simulation, suggesting a rigid lattice and corroborating previous experimental findings. In particular, Na vacancies (created through Zr and Hf substitution on the Y site) resulted in stable quaternary compounds within the Na-Y-M-Cl phase-space associated with relatively low Na-vacancy formation energies compared to higher valent substituents such as Ta. It is interesting to note that, from FIG. 4A, x=0.5 (50% NYZC) shows a low Eₕᵤₗₗ of 5.6 meV/atom, suggesting that zirconium substitution can effectively stabilize the metastable Na₃YCl₆ structure. In addition, it is clearly energetically favorable for Zr to take the place of Y instead of also substituting on the Na site. Thus, zirconium was selected as the dopant of choice after the initial screening process, as well as for other reasons such as stability, improved diffusivity, and experimental processability.

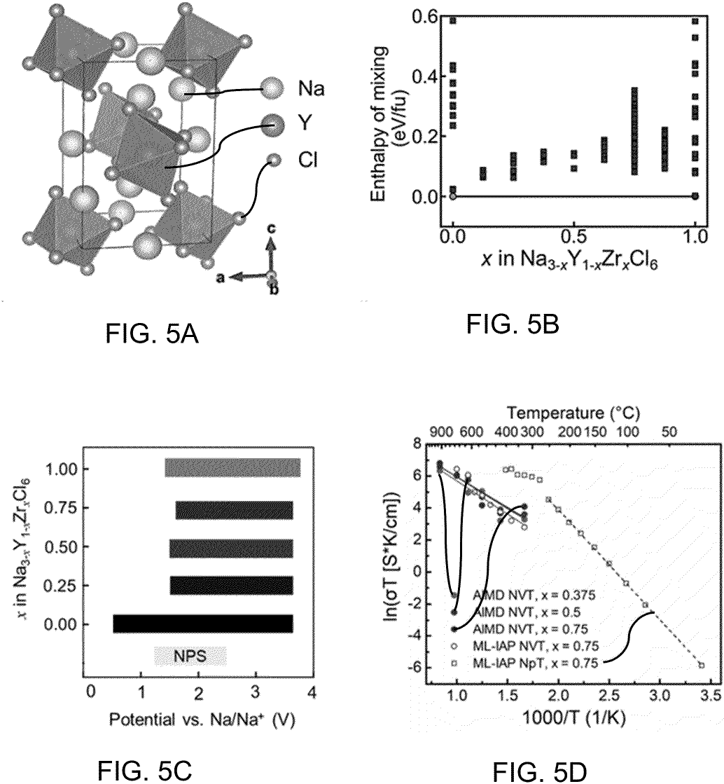

FIGS. 5A-5D show the effect of Zr dopants on properties of Na₃YCl₆, where FIG. 5A illustrates the crystal structure of Na₃YCl₆. FIG. 5B plots stability of Na₃₋ ₓY₁₋ₓZrₓCl₆ after incorporating Zr⁴⁺ into Na₃YCl₆. Each square marker indicates a symmetrically distinct ordering of Na and Y/Zr. FIG. 5C is a graph of the electrochemical stability window of Na₃₋ₓY₁₋ₓZrₓCl₆ (0 ≤x ≤1), with the window of

Na₃PS₄ (NPS) as a reference. FIG. 5D is an Arrhenius plot for Na₃₋ₓY₁₋ₓZrₓCl₆ from AIMD simulations (at x = 0.375, 0.5, and 0.75; solid lines and markers) and Machine Learning Interatomic Potential-based MD simulations (at x = 0.75; dashed lines and open markers). AIMD simulations were carried out at T = 600-1000 K with a 100 K interval, using a supercell of 150 atoms for up to 200 ps, while the ML-IAP MD simulations were carried out at T = 350 K - 650 K using a supercell of 592 atoms for up to 10 ns. Table 2 provides the evolution of the Na diffusion barrier, Eₐ, upon varying x in Na₃₋ₓY₁₋ₓZrₓCl₆.

TABLE 2

| x | Eₐ (meV) |
|---|---|
| 0 (Expt.) | 541 |
| 0.375 | 455 |
| 0.5 | 378 |
| 0.625 | 291 |
| 0.75 | 357 |
| 1 | 400 |

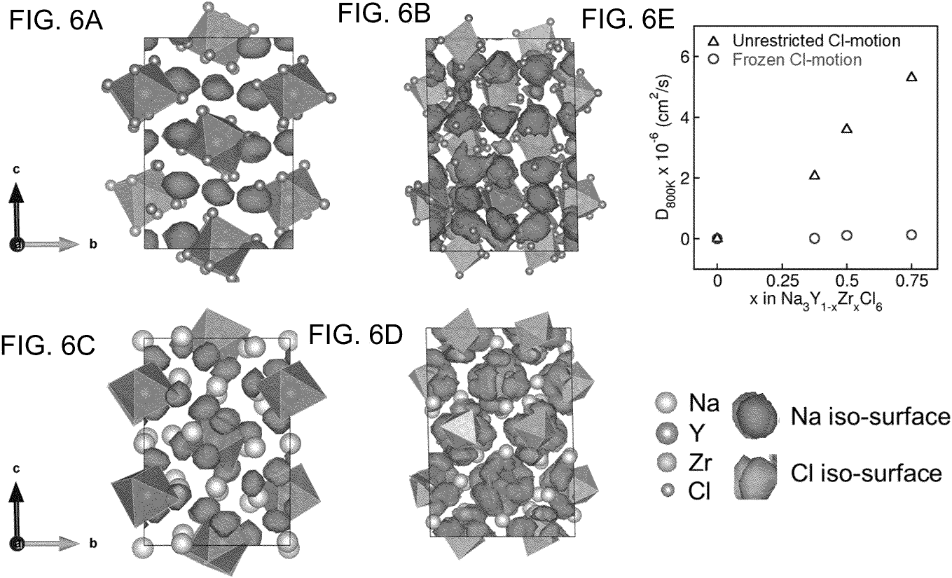

FIGS. 6A-6D are plots of the probability density (isosurface value = 5 × 10⁻⁴) of Na⁺ in Na₃YCl₆ (FIG. 6A), Na⁺ in Na_{2.25}Y_{0.25}Z_{0.75}Cl₆ (FIG. 6B), Cl⁻ in Na₃YCl₆ (FIG. 6C), and Cl⁻ in Na_{2.25}Y_{0.25}Z_{0.75}Cl₆ (FIG. 6D) over 100 ps of AIMD simulations at 600 K. It is evident that the motion of Na⁺ and Cl⁻ in Na₃YCl₆ are relatively localized, while macroscopic Na⁺ diffusion with (Zr/Y)Cl₆ octahedral rotation are observed in Na_{2.25}Y_{0.25}Z_{0.75}Cl₆. FIG. 6E plots the Na⁺ diffusivity at 800 K (D_{800K}, in cm²/s) for varying Zr content in Na₃₋ₓY₁₋ₓZrₓCl₆, compared with a selective dynamics simulation with Cl⁻ ions frozen in space, which shows negligible Na⁺ diffusivity.

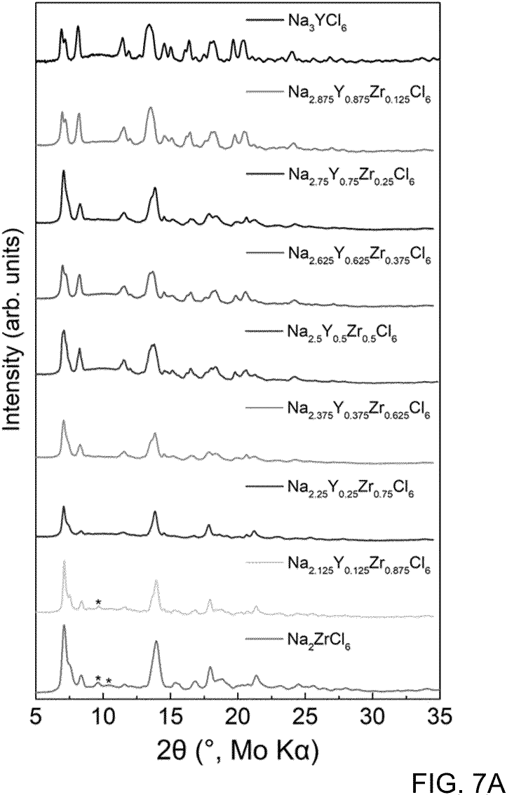

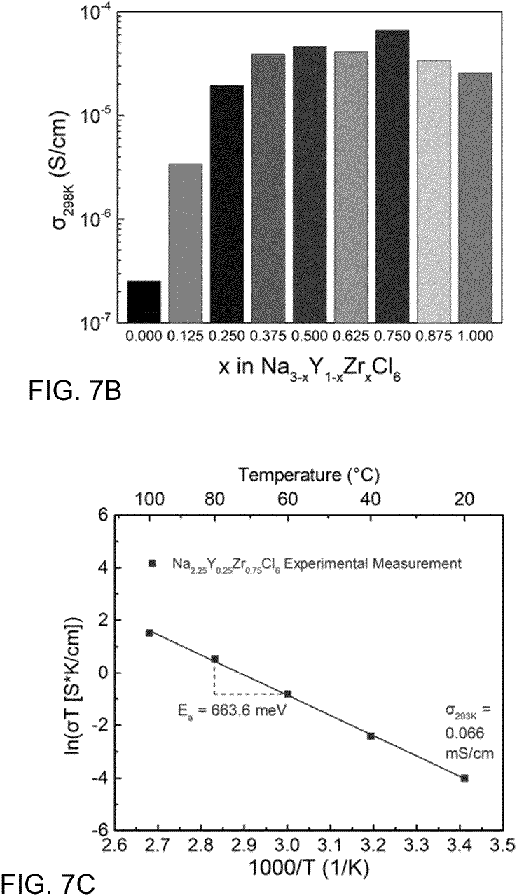

FIGS. 7A-7B, respectively, show the XRD patterns and room temperature Na ionic conductivity values over the Na₃₋ₓY₁₋ₓZrₓCl₆ compositional range in x=0.125 increments. From the XRD patterns in FIG. 7A, it can be seen that from x=0 to x=0.875, the space group of the parent compound NYC is largely retained, while at x=1 (i.e. Na₂ZrCl₆ or NZC) the crystal structure clearly changes. From FIG. 7B it can be seen that all Y and Zr-mixed samples showed a higher conductivity than the end members NYC and NZC. FIG. 7C is the Arrhenius plot of the sample with the highest Na ionic conductivity, Na_{2.25}Y_{0.25}Zr_{0.75}Cl₆ (NYZC0.75).

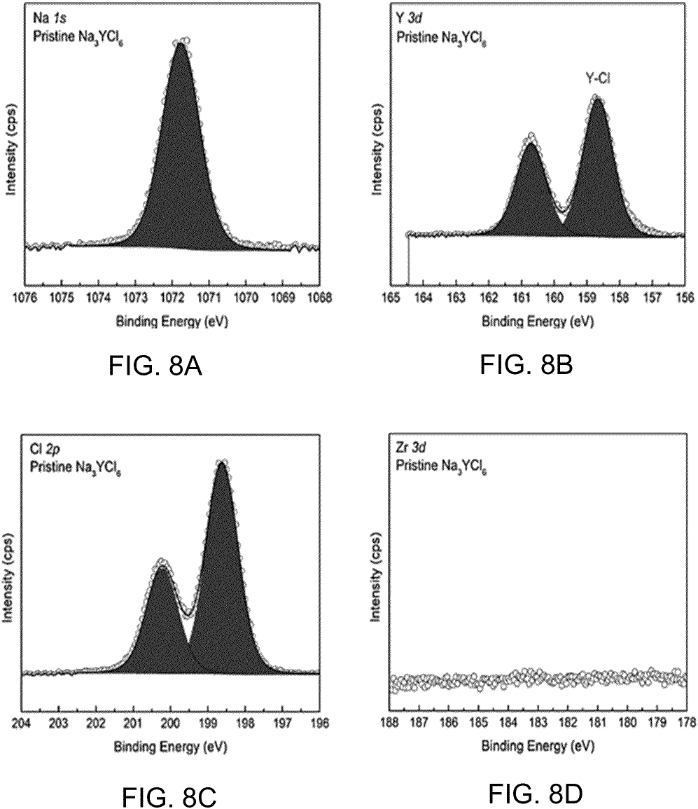

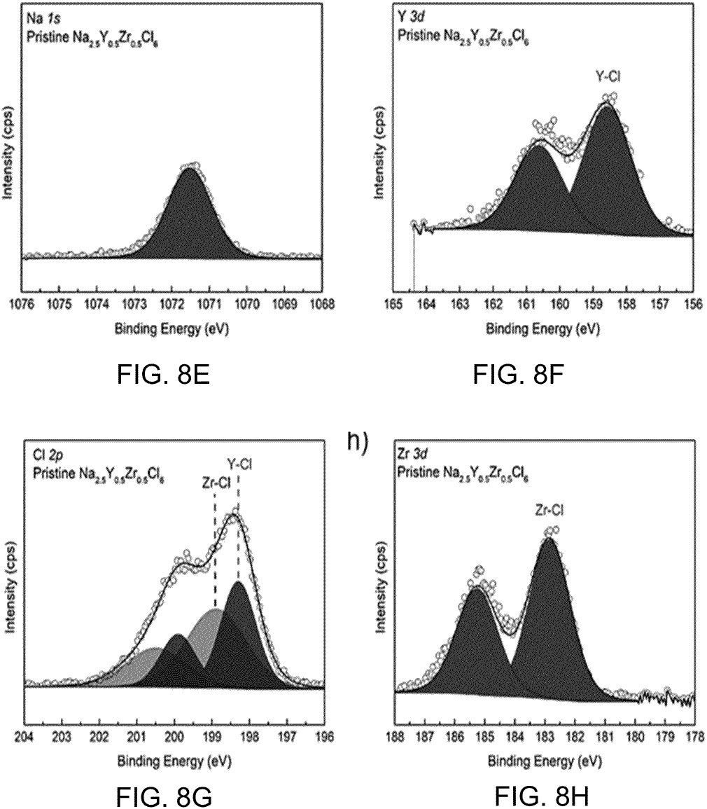

To illustrate that Zr was experimentally incorporated, XPS was conducted on NYC and NYZC0.5. The region scans of the Na 1s, Y 3d, Cl 2p, and Zr 3d binding energy regions are shown, respectively, for NYC (FIGS. 8A-8D) and NYZC0.5 (FIGS. 8E-8H). As shown in FIG. 8G, there are two Cl-containing environments, indicative of Zr—Cl and Y—Cl bonds, as well as a clear signature in FIG. 8H of the Zr—Cl bond (absent in FIG. 8D for NYC). Thus, Zr was incorporated into the parent NYC.

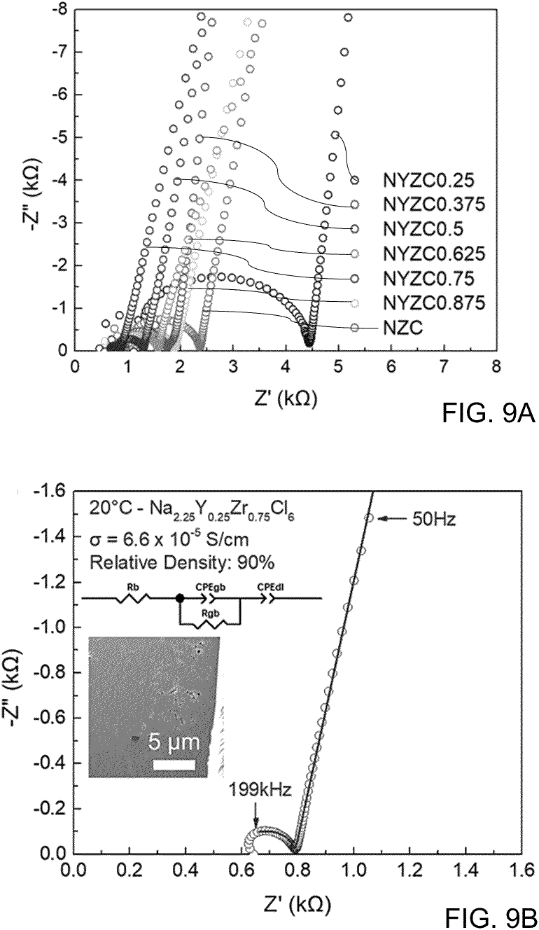

FIGS. 9A and 9B are Nyquist plots for Na₃₋ₓY₁₋ₓZrₓCl₆, 0.25<x<0.75 (shown for scale) and the room temperature Na ionic conductivity for Na_{2.25}Y_{0.25}Zr_{0.75}Cl₆, respectively. Na_{2.25}Y_{0.25}Zr_{0.75}Cl₆ exhibits a room temperature conductivity of 6.6 × 10^{- 5} S/cm.

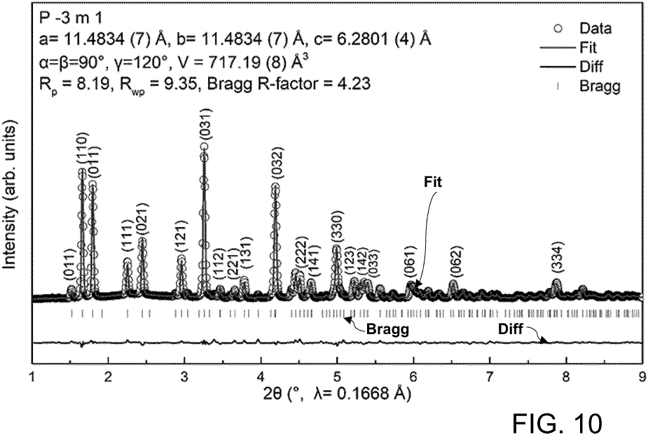

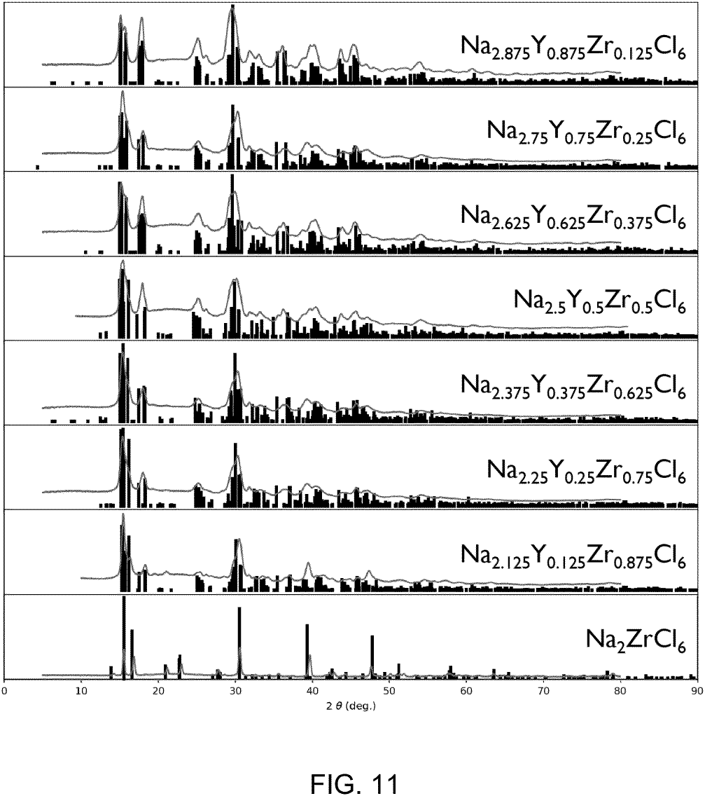

To elucidate the structure of NZC, Rietveld refinement was carried out on synchrotron XRD data (λ = 0.1668 Å). FIG. 10 provides the Rietveld refinement of as-synthesized Na₂ZrCl₆. The structure can be described using the P -3 m 1 space group, analogous to Na₂TiF₆. The cell parameters and fitting parameters are shown in the inset. The parameters listed in Table 3. The results are in good agreement with the computational structural determination conducted by the method of substituting the known structures in the MP database with the formula A₂MX₆ to Na₂ZrCl₆ (illustrated in FIG. 11).

TABLE 3

| Atom | x | y | z | Bᵢₛₒ | SOF |
|---|---|---|---|---|---|
| Zr1 | 0 | 0 | 0 | 1.20 (8) | 0.965 (5) |
| Zr2 | 0.3333 | 0.6667 | 0.4898 (10) | 1.20 (8) | 1 |
| Zr3 | 0 | 0 | 0.37 (2) | 1.20 (8) | 0.035 (2) |
| Cl1 | 0.1012 (11) | 0.8988 (11) | 0.2376 (9) | 3.68 (11) | 1 |
| Cl2 | 0.2316 (5) | 0.7684 (5) | 0.7039 (9) | 3.68 (11) | 1 |
| Cl3 | 0.4348 (11) | 0.5652 (11) | 0.2736 (9) | 3.68 (11) | 1 |
| Na1 | 0.3525 (8) | 0 | 0 | 3.0 (2) | 0.740 (8) |
| Na2 | 0.281 (3) | 0 | 0.5 | 3.0 (2) | 0.260 (8) |

As previous studies have shown, the ionic conductivity is not the only metric that determines the overall performance of an SSE for ASSB applications. Finding chemically compatible electrodes is of vital importance for stable, long-term cycling of an ASSB. Chemical and electrochemical stability between the solid electrolyte and electrodes are required for an efficient solid-state battery. Thus, we evaluated the electrochemical and chemical stability of the highest conductive composition, Na_{2.25}Y_{0.25}Zr_{0.75}Cl₆, before testing it in an ASSB.

Electrochemical stability windows were determined for Na_{2.25}Y_{0.25}Zr_{0.75}Cl₆ as well as the end-member compound NYC and Na₃PS₄ (NPS). The results are shown in Table 4 with the computed reaction Energies (with NaCrO₂ and Na metal) and the electrochemical windows of NYC, Na_{2.25}Y_{0.25}Zr_{0.75}Cl₆, and Na₃PS₄.

TABLE 4

| System | Reaction energy w/ NaCrO₂ (eV/atom) | Reaction energy w/Na (eV/atom) | EC window (V) |
|---|---|---|---|
| Na₃YCl₆ | -0.11 | -0.13 | 0.6-3.8 |
| Na_{2.25}Y_{0.25}Zr_{0.75}Cl₆ | -0.14 | -0.34 | 1.5-3.8 |
| Ref: c-Na₃PS₄ | -0.18 | -0.46 | 1.2-2.5 |

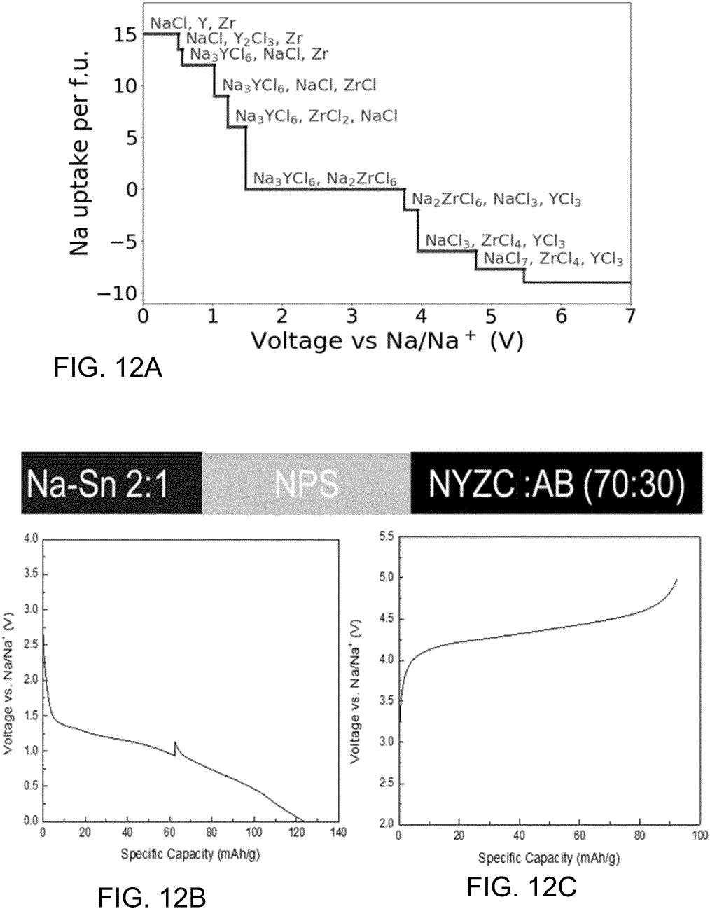

The incorporation of Zr narrows the electrochemical window on the anode side while the upper limit (cathode side) is maintained. This is mainly due to the higher thermodynamic reduction potential of Zr⁴⁺ compared to Y³⁺ (the oxidation potential contribution is independent of the metal oxidation state as both Y and Zr are in their highest oxidation state). Compared to the upper voltage stability limit of 2.5 V for NPS, the limit for Na_{2.25}Y_{0.25}Zr_{0.75}Cl₆ is 3.8 V, much more promising for high-voltage Na ASSB applications. In addition, the reaction energies with the NaCrO₂ cathode and with metallic Na were also computed; in each case, the values were found to be less negative than for NPS. This suggests that NYZC is a promising SSE candidate for its superior electrochemical and chemical stability when in contact with common electrode materials. In addition, the grand potential phase diagram of Na_{2.25}Y_{0.25}Zr_{0.75}Cl₆ was computed to evaluate the stability window and the reaction products at different voltages (FIG. 12A).

Experimentally, two test cells composed of a Na—Sn 2:1 alloy anode, a Na₃PS₄ electrolyte, and Na_{2.25}Y_{0.25}Zr_{0.75}Cl₆ mixed with carbon (acetylene black, or AB, in a 70:30 NYZC:AB ratio) cathode were fabricated to determine the lower and upper potential values at which the Na_{2.25}Y_{0.25}Zr_{0.75}Cl₆ SSE is stable; one cell was discharged to 0 V (FIG. 12B) and the other charged to 5 V. Referring to FIG. 12C, the reduction and oxidation onset potentials of NYZC are close to 1.5 and 3.8 V respectively, the values obtained from the computed grand potential phase diagram.

Given the results for the electrochemical window of Na_{2.25}Y_{0.25}Zr_{0.75}Cl₆, to electrochemically evaluate it in an ASSB, the following model system was used: Na—Sn alloy (2:1) for the anode, Na₃PS₄ for the electrolyte, and NaCrO₂ for the cathode. NaCrO₂ was chosen due to its operating voltage of 2-3.6 V, which is within the stability window of Na_{2.25}Y_{0.25}Zr_{0.75}Cl₆. The cathode was mixed into a composite cathode according to the Methods section.

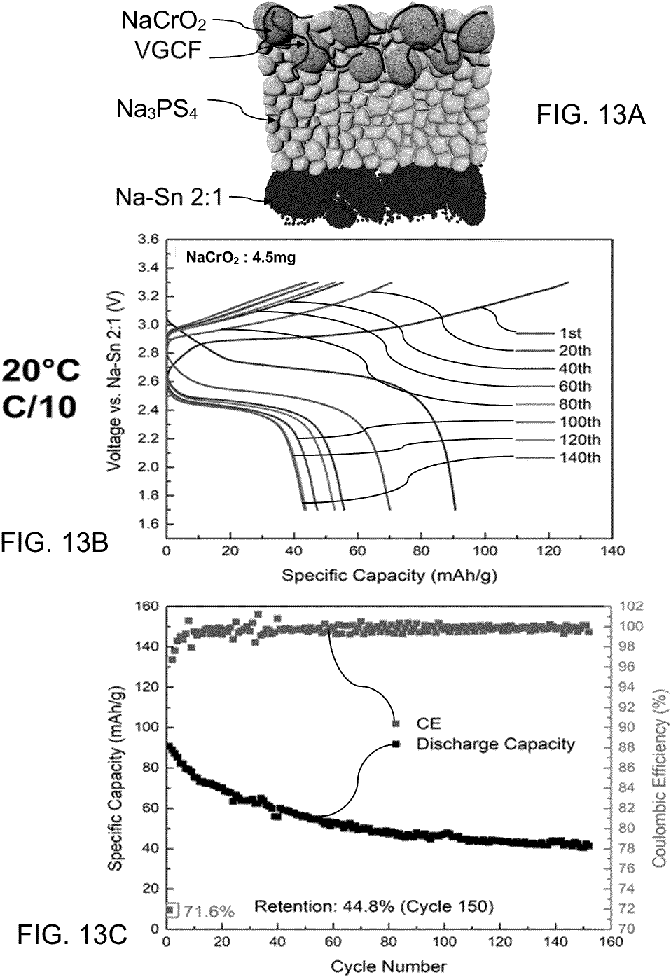

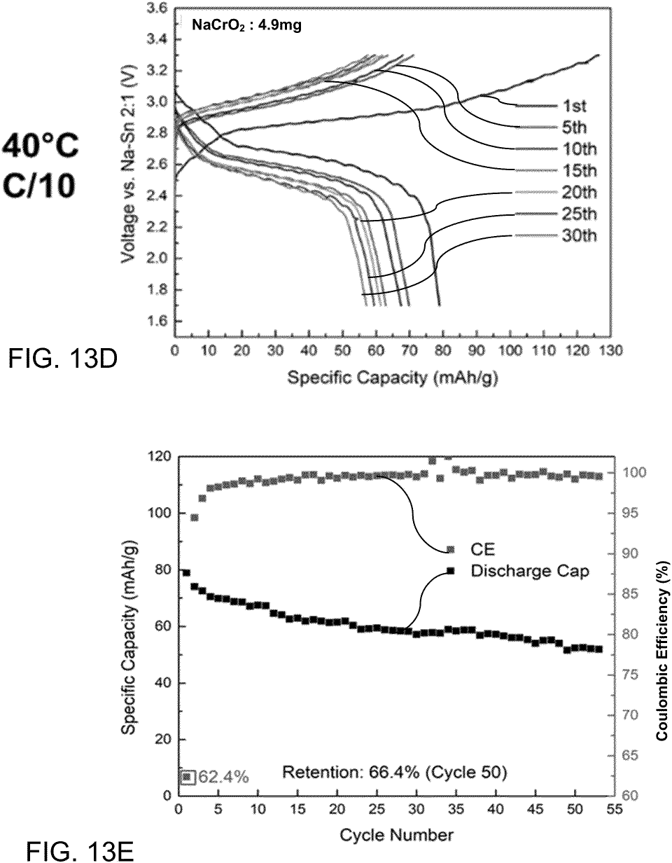

FIG. 13A shows the cell schematics of the NPS-only cell. FIGS. 13B-13C provide the voltage profile and capacity as a function of cycle number for room temperature cycling, respectively, at 20° C. and at a rate of C/10. Referring to FIG. 13C, the first cycle Coulombic efficiency (CE) for the NPS-only cell was 71.6%, indicative of oxidative decomposition of Na₃PS₄, and the capacity retention was just 44.8% after cycle 150, indicative of gradual cell degradation. The same type of NPS-only cell was also cycled at a slightly elevated temperature of 40° C. at a rate of C/10. FIGS. 13D-13E, respectively, show the voltage profile and capacity as a function of cycle number at these conditions. Oxidative decomposition is more pronounced at 40° C., with a drop in the first cycle CE from 71.6% at 20° C. to 62.4% at 40° C. In addition, capacity retention was only 66.4% after 50 cycles.

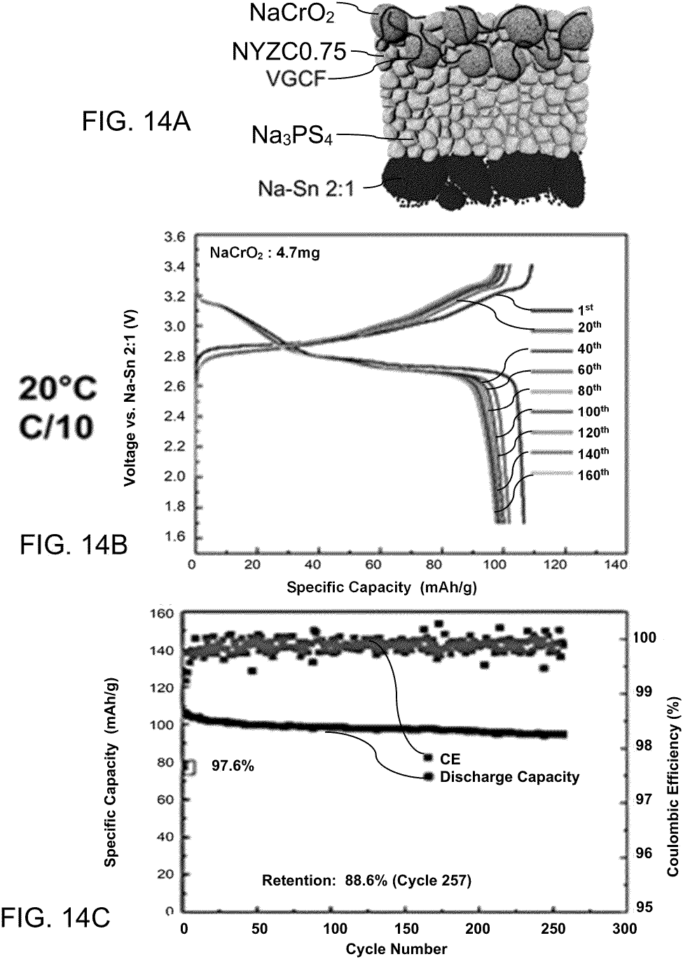

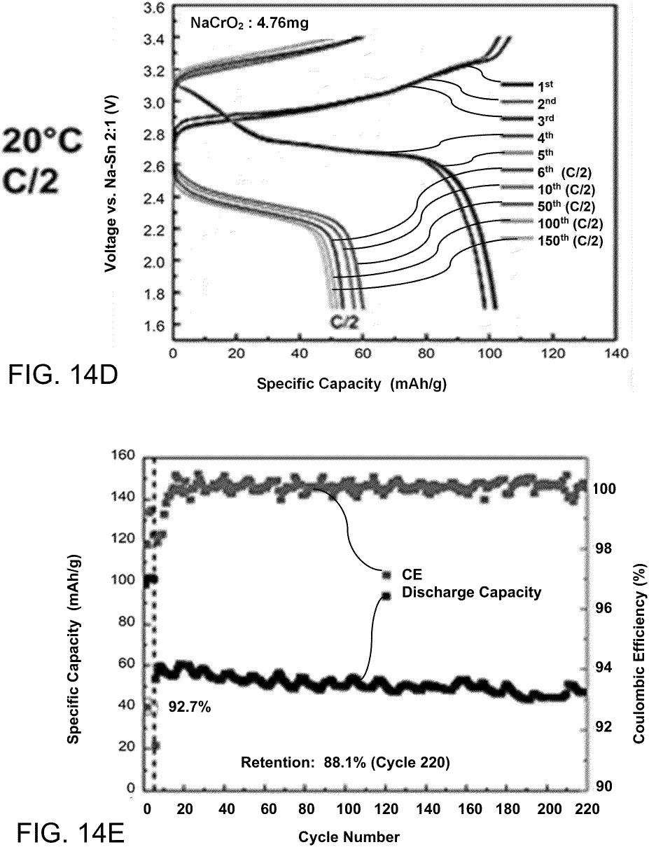

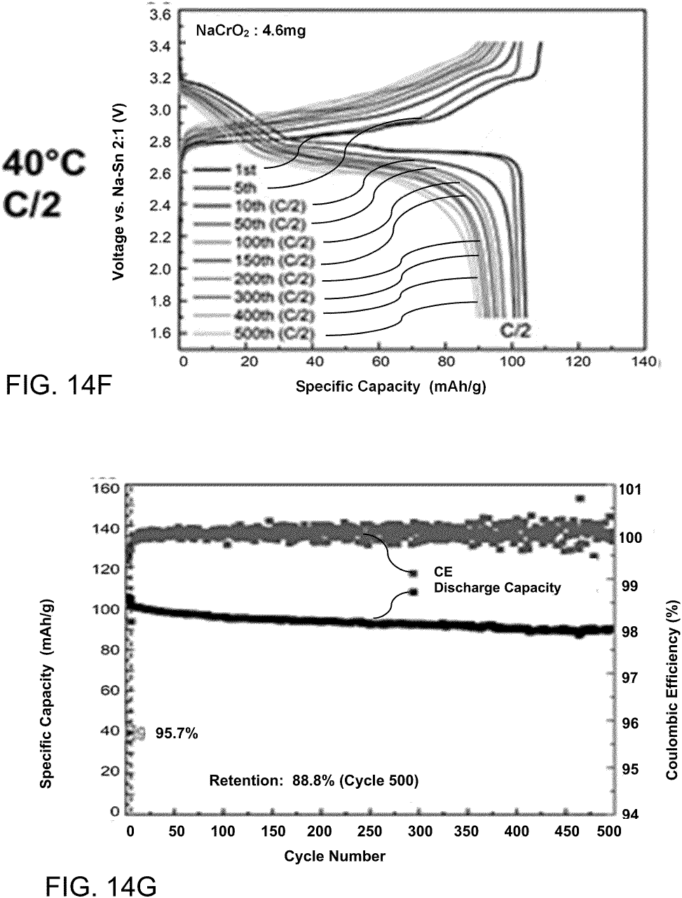

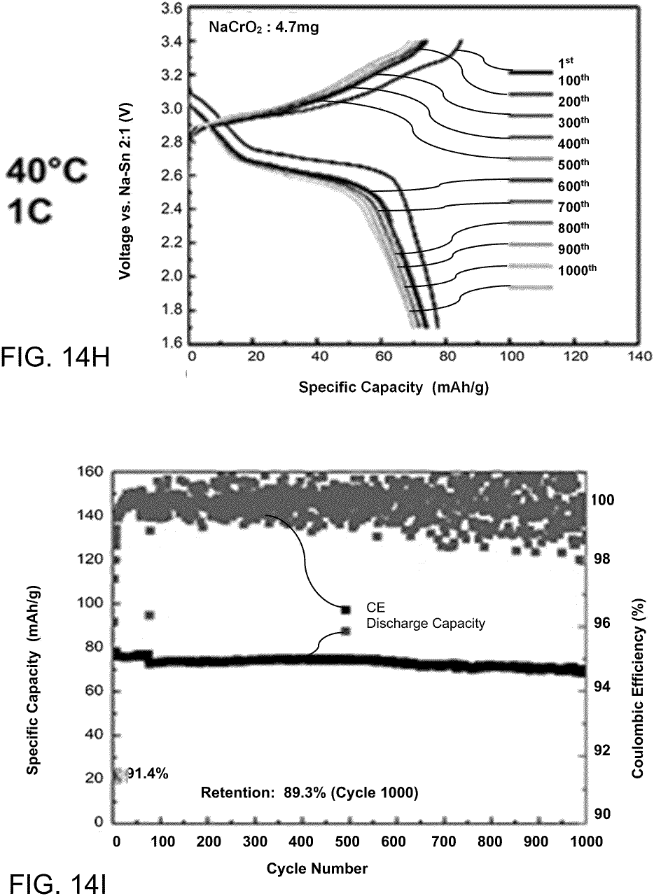

FIG. 14A shows the cell schematic of the cell with Na_{2.25}Y_{0.25}Zr_{0.75}Cl₆ in the composite cathode. FIGS. 14B-14C, respectively, show the voltage profile and capacity as a function of cycle number at 20° C. and at a rate of C/10. Compared to the NPS-only cell, the first cycle CE drastically increased in the cell containing Na_{2.25}Y_{0.25}Zr_{0.75}Cl₆ (from 71.6% to 95.6%). FIGS. 14D-14E show the voltage profile and capacity as a function of cycle number, respectively, at 20° C. and at a rate of C/2. At 40° C. and at a cycling rate of C/2, negligible drop in capacity is observed (from 104 to 101 mAh/g) compared to a drop to ~60 mAh/g for C/2 at 20° C. as seen in FIG. 14D. At 40° C., reaction kinetics increase (while also exacerbating any unwanted reactions, as in the case of the NPS-only cell), and the conductivity of Na_{2.25}Y_{0.25}Zr_{0.75}Cl₆ falls in the range of 1-2×10⁻⁴ S/cm, which is more favorable for fast cycling. FIGS. 14F-14G show the results for 40° C. and a rate of C/2, showing good capacity retention (88.8%) after 500 cycles, and FIGS. 14H-14I show the results for 40° C. and a rate of 1 C, showing similar capacity retention (89.3%) but after 1000 cycles.

In each case, the capacity retention and the observed CE values are very high, the CE values being the highest among all of those reported for Na ASSBs that use a NaCrO₂ cathode. This is a result of negligible oxidative decomposition of Na_{2.25}Y_{0.25}Zr_{0.75}Cl₆ as well as its superior chemical stability against NaCrO₂. It is important to note that NaCrO₂ does not have any protective coating layer, eliminating an additional step in the ASSB fabrication process. The result is similar the one observed in the previously mentioned report of the lithium analog Li₃YCl₆. These cycling results highlight the superior stability obtained by adding Na_{2.25}Y_{0.25}Zr_{0.75}Cl₆ on the cathode side, further corroborating the computational findings.

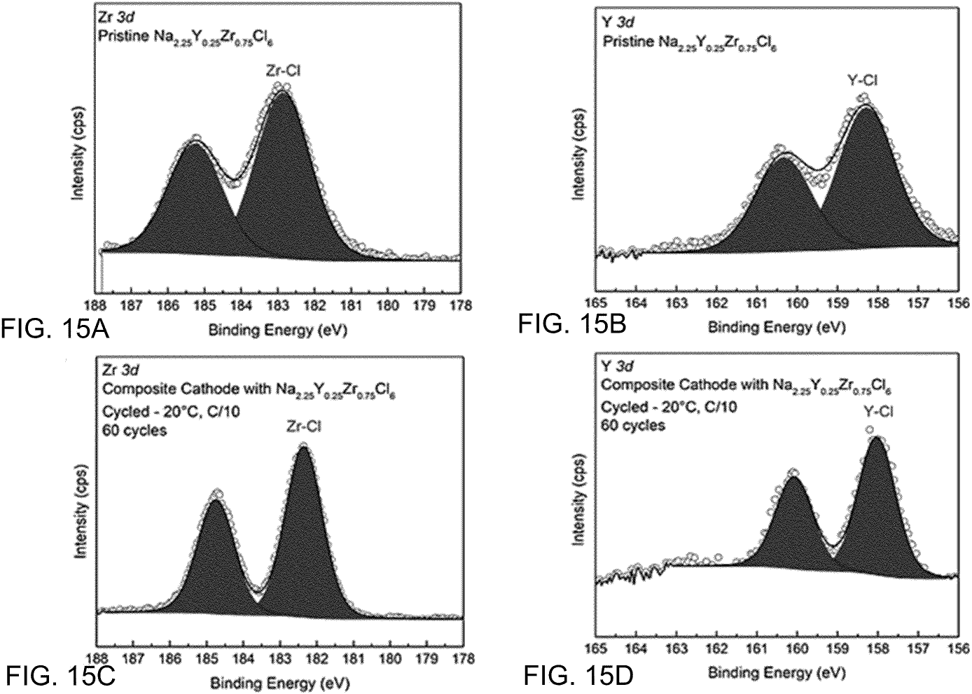

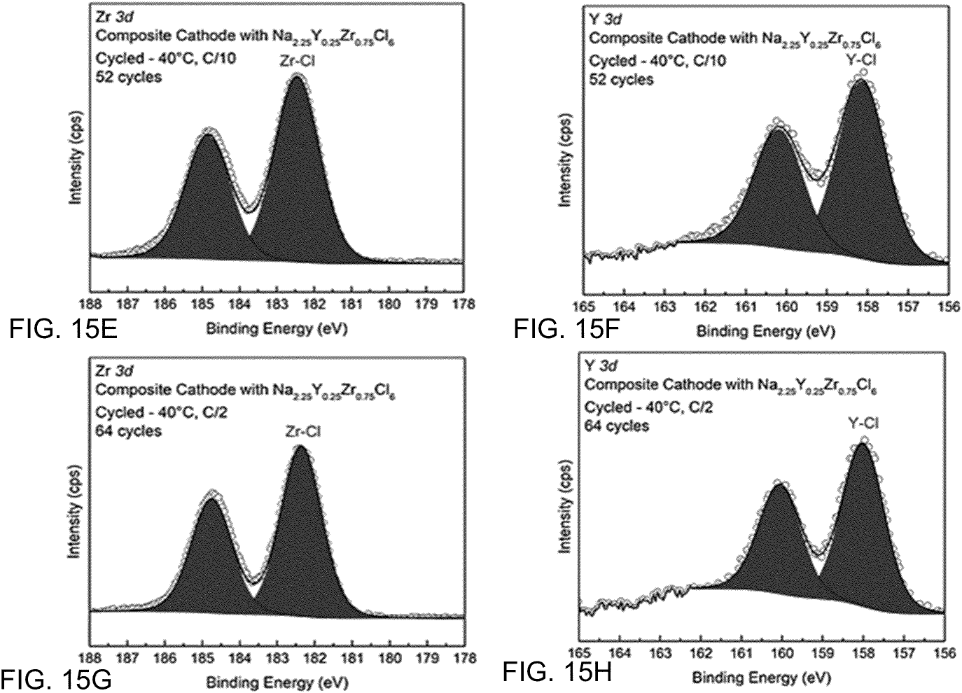

To characterize any changes in Na_{2.25}Y_{0.25}Zr_{0.75}Cl₆ after cycling, ASSBs were disassembled to recover the composite cathodes and XPS measurements were conducted. FIGS. 15A-15H show the Zr 3d and Y 3d bonds of pristine (FIGS. 15A-15B) versus cycled Na_{2.25}Y_{0.25}Zr_{0.75}Cl₆. Even when cells were cycled at elevated temperatures or higher rates, the Zr—Cl and Y—Cl bonds in Na_{2.25}Y_{0.25}Zr_{0.75}Cl₆ are retained, confirming no change in the bonding environment and thus the superior electrochemical and chemical stability of Na_{2.25}Y_{0.25}Zr_{0.75}Cl₆ against NaCrO₂.

As described in the foregoing disclosure, Na₃YCl₆ was computationally and experimentally evaluated for its electrochemical properties and performance. Through aliovalent substitution of Y³⁺ by Zr⁴⁺, yielding Na₃₋ₓY₁₋ₓZrₓCl₆, it was found that the Na diffusivity drastically increased, reflected in the ionic conductivity increase by two orders of magnitude (for compositions with x<1). Furthermore, the electrochemical window, especially on the cathode side, was retained even with the incorporation of Zr, and the upper limit of 3.8 V proved to be significantly beneficial especially when using NaCrO₂ as the cathode in a Na ASSB. Through electrochemical results and characterization techniques such as XPS, no significant degradation of NYZC was observed with prolonged cycling.

### References (Incorporated Herein by Reference)

1. Bachman, J. C. et al. Inorganic Solid-State Electrolytes for Lithium Batteries: Mechanisms and Properties Governing Ion Conduction. Chem. Rev. 116, 140-162 (2016).

2. Lau, J. et al. Sulfide Solid Electrolytes for Lithium Battery Applications. Adv. Energy Mater. 8, 1800933 (2018).

3. Richards, W. D., Miara, L. J., Wang, Y., Kim, J. C. & Ceder, G. Interface Stability in Solid-State Batteries. Chem. Mater. 28, 266-273 (2016).

4. Tan, D. H. S. et al. Elucidating Reversible Electrochemical Redox of Li6PS5Cl Solid Electrolyte. ACS Energy Lett. 4, 2418-2427 (2019).

5. Banerjee, A. et al. Revealing Nanoscale Solid-Solid Interfacial Phenomena for Long-Life and High-Energy All-Solid-State Batteries. ACS Appl. Mater. Interfaces 11, 43138-43145 (2019).

6. Tang, H. et al. Probing Solid-Solid Interfacial Reactions in All-Solid-State Sodium-Ion Batteries with First-Principles Calculations. Chem. Mater. 30, 163-173 (2018).

7. Asano, T. et al. Solid Halide Electrolytes with High Lithium-Ion Conductivity for Application in 4 V Class Bulk-Type All-Solid-State Batteries. Adv. Mater. 30, 1803075 (2018).

8. Li, X. et al. Air-stable Li ₃ InCl ₆ electrolyte with high voltage compatibility for all-solid-state batteries. Energy Environ. Sci. 12, 2665-2671 (2019).

9. Wang, Y. et al. Development of solid-state electrolytes for sodium-ion battery-A short review. Nano Mater. Sci. 1, 91-100 (2019).

10. Banerjee, A. et al. Na3SbS4: A Solution Processable Sodium Superionic Conductor for All-Solid-State Sodium-Ion Batteries. Angew. Chem. Int. Ed. 55, 9634-9638 (2016).

11. Nguyen, H. et al. Experimental and Computational Evaluation of a Sodium-Rich Anti-Perovskite for Solid State Electrolytes. J. Electrochem. Soc. 163, A2165-A2171 (2016).

12. Richards, W. D. et al. Design and synthesis of the superionic conductor Na10SnP2S12. Nat. Commun. 7, 1-8 (2016).

13. Park, K. H. et al. Solution-derived glass-ceramic NaI·Na3SbS4 superionic conductors for all-solid-state Na-ion batteries. J. Mater. Chem. A 6, 17192-17200 (2018).

14. Hayashi, A. et al. A sodium-ion sulfide solid electrolyte with unprecedented conductivity at room temperature. Nat. Commun. 10, 1-6 (2019).

15. Deng, Z., Wang, Z., Chu, I.-H., Luo, J. & Ong, S. P. Elastic Properties of Alkali Superionic Conductor Electrolytes from First Principles Calculations. J. Electrochem. Soc. 163, A67-A74 (2016).

16. Chu, I.-H. et al. Room-Temperature All-solid-state Rechargeable Sodium-ion Batteries with a Cl-doped Na 3 PS 4 Superionic Conductor. Sci. Rep. 6, 1-10 (2016).

17. Lacivita, V., et al.,. Ab initio investigation of the stability of electrolyte/electrode interfaces in all-solid-state Na batteries. J. Mater. Chem. A 7, 8144-8155 (2019).

18. Kresse, G. & Furthmüller, J. Efficient iterative schemes for ab initio total-energy calculations using a plane-wave basis set. Phys. Rev. B 54, 11169-11186 (1996).

19. Blochl, P. E. Projector augmented-wave method. Phys. Rev. B 50, 17953-17979 (1994).

20. Perdew, J. P., et al., Generalized Gradient Approximation Made Simple. Phys. Rev. Lett. 77, 3865-3868 (1996).

21. Ong, S. P. et al. Python Materials Genomics (pymatgen): A robust, open-source python library for materials analysis. Comput. Mater. Sci. 68, 314-319 (2013).

22. Deng, Z., et al., Data-Driven First-Principles Methods for the Study and Design of Alkali Superionic Conductors. Chem. Mater. 29, 281-288 (2017).

23. Jain, A. et al. Commentary: The Materials Project: A materials genome approach to accelerating materials innovation. APL Mater. 1, 011002 (2013).

24. Ong, S. P. et al. The Materials Application Programming Interface (API): A simple, flexible and efficient API for materials data based on REpresentational State Transfer (REST) principles. Comput. Mater. Sci. 97, 209-215 (2015).

25. Bergerhoff, G., et al., The inorganic crystal structure data base. J. Chem. Inf. Comput. Sci. 23, 66-69 (1983).

26. Hautier, G., et al., Data Mined Ionic Substitutions for the Discovery of New Compounds. Inorg. Chem. 50, 656-663 (2011).

27. Jain, A. et al. A high-throughput infrastructure for density functional theory calculations. Comput. Mater. Sci. 50, 2295-2310 (2011).

28. Willems, T. F., et al., Algorithms and tools for high-throughput geometry-based analysis of crystalline porous materials. Microporous Mesoporous Mater. 149, 134-141 (2012).

29. Jónsson, H., et al., Nudged Elastic Band Method for Finding Minimum Energy Paths of Transitions. in (1998). doi:10.1142/9789812839664_0016.

30. Shapeev, A. V., Moment Tensor Potentials: A Class of Systematically Improvable Interatomic Potentials. Multiscale Model. Simul. 14, 1153-1173 (2016).

31. Podryabinkin, E. V. & Shapeev, A. V. Active learning of linearly parametrized interatomic potentials. Comput. Mater. Sci. 140, 171-180 (2017).

32. Gubaev, K., et al., Accelerating high-throughput searches for new alloys with active learning of interatomic potentials. Comput. Mater. Sci. 156, 148-156 (2019).

33. Plimpton, S. Fast parallel algorithms for short-range molecular dynamics. https://www.osti.gov/biblio/10176421 (1993) doi:10.2172/10176421.

1. A composition for sodium-based all-solid-state batteries, comprising a halide compound comprising a sodium solid electrolyte based on a parent compound Na₃YCl₆, wherein sodium diffusivity within the halide compound is enhanced through substitution of Y or Na with one or more of Zr, Ti, Hf, Ta, Ca, Sr, Mg, and Fe.

2. (canceled)

3. The composition of claim 1, wherein the electrolyte is an engineered framework with Na-deficiency compared to the parent Na₃YCl₆.

4. The composition of claim 1, wherein the electrolyte is Na₃-ₓY₁₋ₓZrₓCl₆ where 0 < x < 1.

5. The composition of claim 4, wherein the electrolyte is Na_{2.25}Y_{0.25}Zr_{0.75}Cl_{6.}

6. A sodium-based all-solid-state battery comprising:
a sodium-based solid electrolyte, wherein sodium diffusivity within the electrolyte is enhanced through substitution of Y or Na with one or more of Zr, Ti, Hf, Ta, Ca, Sr, Mg, and Fe; and
a composite cathode comprising an oxide cathode.

7. The battery of claim 6, further comprising an Na alloy anode, wherein the Na alloy comprises NaₓSn, NaₓSb, or NaₓSn_{y}Sb_{1-y}, where x is between 0 to 3.75.

8. The battery of claim 7, wherein the electrolyte is stable with the Na alloy.

9. The battery of claim 6, wherein the oxide cathode is a transition metal oxide cathode.

10. The battery of claim 6, wherein the oxide is NaCrO2.

11. The battery of claim 6, wherein the electrolyte is Nₐ₃PS₄.

12. The battery of claim 6, wherein the battery has a capacity retention of greater than 80% after more than 200 cycles.

13. (canceled)

14. A sodium-based all-solid-state battery comprising a sodium-based solid electrolyte, a transition metal oxide cathode, and a halide compound characterized in that one or more metallic elements M selected from Zr, Ti, Hf, Ta, Ca, Sr, Mg, and Fe are substituted into pristine Nₐ₃ YCl₆ to define a buffer layer between the solid electrolyte and the cathode.

15. The battery of claim 14, where the cathode and the buffer layer each comprise a composite comprising an engineered framework with Na-deficiency compared to pristine Nₐ₃ YCl₆.

16. The battery of claim 14, further comprising an anode comprising a Na alloy selected NaₓSn, NaₓSb, and NaₓSn_{y}Sb_{1-y}, where x is between 0 and 3.75.

17. The battery of claim 15, wherein the solid-state electrolyte is stable with the composite.

18. The battery of claim 14, wherein the cathode is NaCrO2.

19. The battery of claim 14, wherein the solid electrolyte is Na₃PS_{4.}

20. The battery of claim 14, wherein one or both of the cathode and the buffer layer comprises of Na₃₋ₓY₁₋ₓZrₓCl₆ where 0 < x < 1.

21. The battery of claim 19, wherein one or both of the cathode and the buffer layer comprises Na_{2.25}Y_{0.25}Zro_{.75}Cl_{6.}

22. The battery of claim 14, wherein the battery has a capacity retention of greater than 80% after more than 200 cycles.

23. (canceled)

24. A composition comprising a sodium-ion conducting material configured for use as an interface between a high voltage oxide cathode and a sodium-based solid electrolyte in a sodium all-solid-state battery, wherein the material is based on a parent compound Na₃YCl₆ , wherein Na or Y is substituted with one or more of Zr, Ti, Hf, Ta, Ca, Sr, Mg, and Fe.

25. The composition of claim 24, wherein the material is Na₃₋ₓY₁₋ₓZrₓCl6 where 0 < x < 1.

26. The composition of claim 24, wherein the material is Na_{2.25} Y_{0.25}Zr_{0.75}Cl₆.
